(19) United States
(12) Patent Application Publication
(10) Pub. No.: US 2009/0241278 A1
(43) Pub. Date: Oct. 1, 2009

(54) Apparatus And Method For Monitoring Dental Brushing Performance With A Conventionally Manufactured Toothbrush

(76) Inventor: Marc Lemchen, New York, NY (US)

Correspondence Address: Law Offices of Daniel L. Dawes, 5200 Warner Blvd, Ste. 106, Huntington Beach, CA, 92649, US

(21) Appl. No.: 12/394,019

(22) Filed: Feb. 26, 2009

Related U.S. Application Data
(60) Provisional application No. 61/041,376, filed on Apr. 1, 2008.

(51) Int. Cl. A46B 15/00; G09B 19/00

(52) U.S. Cl. 15/105; 434/262

(57) ABSTRACT

A removable and transferable electronic system monitors the brushing patterns and brushing intensity of a user by analyzing the sound(s) that is produced by a conventional tooth brush as it passes over the teeth and/or gums. The system couples to the toothbrush and the brushing sounds are captured by a microphone coupled to the toothbrush which is then communicated to a microprocessor coupled to a digital display. After the microprocessor has analyzed the brushing sounds, a message is displayed on the digital display that directs the user to continue brushing or change brushing habits, depending on the outcome of the analysis. After brushing, the system may be decoupled from the toothbrush and stored or coupled to another user's toothbrush and the process repeated.

### RELATED APPLICATIONS

The present application is related to U.S. Provisional Patent Application, Ser. No. 61/041,376, filed on Apr. 1, 2008, which is incorporated herein by reference and to which priority is claimed pursuant to 35 USC 119.

### BACKGROUND OF THE INVENTION

1. Field of the Invention

The invention relates to the field of computer assisted dental maintenance of teeth, particularly through the analysis of various sound patterns produced by a toothbrush as it passes over the teeth and gums of a user and/or the movement relative to a microphone array.

2. Description of the Prior Art

Oral health remains a widespread problem across with more than half of adults having some form of gingivitis, and 75 percent of people over the age of 35 having some form of gum disease. Tooth loss is also a common problem among Americans, with one in four adults age 60 and older having lost all his or her teeth. The average person spends about 47 seconds brushing his or her teeth, less than half the 2 minutes recommended. Additionally, many people brush too hard, which can contribute to early gum recession. In fact, Americans lose up to 164 million hours of work each year due to dental visits or dental diseases related in some manner to brushing or the lack thereof.

The current state of the art in oral hygiene is increasingly directed to patient compliance and devices which monitor the same. For example, several toothbrushes or dental cleaning devices found in the prior art comprise wireless displays that visually help consumers improve their brushing habits to promote cleaner teeth and healthier gums. These devices help consumers brush in a recommended manner, thoroughly and gently, by combining wireless technology with the most common learning style, visual stimulation, to improve consumers' brushing habits.

Many of these prior art devices comprise a brushhead, a handle, and a visual display that all work together so users can receive visual cues that help them brush better. However, these same prior art devices are custom designed to include the electronics within them. For example, the brushhead and handle are embedded with microchips which communicate with the wireless display to signal when you are brushing too hard, when to move to the next quadrant of the mouth, when you have brushed for two minutes, and when it is time to replace the brushhead.

While the dental cleaning devices found in the prior art are not without their respective successes, indeed users who use them are up to four times more likely to brush the dental-recommended two minutes and reduce their aggressive brushing behavior, they require the user to purchase a completely new dental cleaning system at great expense. Additionally, these prior art devices are customized or have the electronics built into them and hence can only be supplied by the manufacturer to an individual user. This means that when a potential group of users, for example the members of a family, wish to use the prior art cleaning system, each individual family member must purchase their own separate system.

What is needed is a system and a method for cleaning teeth that can be employed with any variety of conventional toothbrushes, each conventional toothbrush used by different a user, and yet still allow each user to receive unique visual cues as to their particular brushing habits and thus improve their overall brushing skills and dental health.

### BRIEF SUMMARY OF THE INVENTION

The illustrated embodiments of the invention include an apparatus for monitoring compliance with a predetermined oral hygiene program utilizing a conventional toothbrush comprising a removable microphone or remote microphone with means for receiving acoustic signals generated by the oral use of the toothbrush, a electronic display coupled to the removable microphone with means for displaying selected parameters related to the oral use of the toothbrush, and a microprocessor coupled to the display to identify, record and report the acoustic signals. The apparatus is taught the brushing sound patterns of the predetermined oral hygiene program.

Consider further the question of how to “teach” the system what sounds would be heard during the ideal brushing regimen. In one embodiment, the user, if an adult, would teach the system by brushing carefully in the manner prescribed by their dentist, using the correct tooth brush. The user would monitor the time, be careful to cover all areas as instructed, and carefully control the pressure of their brushing. With a child this procedure could be done with a supervising adult. The process could also be “taught” in the dental office by the dentist, dental assistant or hygienist. In addition, prelearned templates that may or may not be related to specific tooth brush brands and models to take into account the “sounds” of the bristles for different soft, medium, hard, etc. brushes.

Certain measurements or teaching steps are easily set, such as time. Others may require more sophisticated training, similar to speech recognition. The instructions might say, “for the next five brushing episodes, brush carefully for the full time (set by the user), being careful to cover every surface of the tooth as directed by your dentist.”

In addition to monitoring the sound of brushing patterns to be able to categorize the brushing, another way of monitoring movement would be sonic. If the brush handle had a buzz, or beep and there were two, or three sensors mounted on a “brushing mirror” we could record in two or three dimensions the brushing pattern. This is much more complicated than the sound recognition system. It is similar to the original Dolphin Digigraph or computer note taking systems where the position of the “pen” is mapped as the user writes.

The removable microphone is coupled to or in the toothbrush itself and is then coupled to the microprocessor. The removable microphone is coupled to the microprocessor via a wire that is coupled to the microphone at its distal end and to the microprocessor at its proximal end. In another embodiment, the microphone is coupled to the microprocessor via a wireless transceiver that is coupled to the microphone, and a receiver that is coupled to the microprocessor. In yet another embodiment, the microphone is coupled to the microprocessor directly via a remote that is coupled to the microprocessor and placed within the brushing area.

The microphone could be placed anywhere, and not necessarily on the handle of the brush, although that position is preferred. The microphone might, for example, be on the display or on the mirror in the bathroom, forcing the brusher to “watch” what they are doing. It could be coupled by a small clamp to the handle, or any of the means disclosed in this specification.

The illustrated embodiment contemplates the inclusion of a device embedded in a toothbrush at time of manufacture. The toothbrush need not be an automatic tooth brush, but includes a system with the ability to monitor brushing in a manual brush, or a manual brush with replaceable heads so the electronics is fixed or universal. This way multiple family members could use the same handle, or the heads could be replaced when worn out or ones with different properties, i.e., soft, hard, large, small. Part of the sensor in the handle could look for the temperature of a hand holding it.

In addition, could we use an RFID type of transmitter with a reader that was sensitive enough to pick up changes in distances, so it would know if the RFID in the brush was moving or not, including speed changes.

The microprocessor further comprises a means or electroacoustic circuit for recording the sounds of brushing patterns and brushing intensity produced by the toothbrush passing over a user's teeth and acquired by the removable or remote microphone.

The microprocessor further comprises a means or software controlled processor for analyzing a incoming sound, determining if brushing is taking place, and then sending a signal to the display notifying the user whether brushing has begun or not.

The microprocessor further comprises a means or software controlled processor for analyzing of an incoming sound to within a pre-selected margin of error. The analysis of an incoming sound to within a pre-selected margin of error further comprises a means or circuit for sending a signal to the display to notify the user that effective brushing is taking place when the incoming sound is within the pre-selected margin of error, and that ineffective brushing is taking place when the incoming sound is not within the pre-selected margin of error.

In another embodiment, the microprocessor further comprises a means or circuit for filtering out extraneous sounds, such as the sound of the electric motor of an electric toothbrush.

In yet another embodiment, the microprocessor further comprises a means or circuit and adapter for customizing to whatever toothbrush the user may be using to evaluate the pattern, time, and intensity of brushing and any other performance parameter.

In another embodiment, the microprocessor further comprises a means or circuit and printer for producing data as a printed report.

In a related embodiment, the microprocessor further comprises a means or circuit and modem for wirelessly uploading a dental data report to a computer or website and a means or circuit and modem for e-mailing a dental data report to a computer or website.

The present invention also comprises a method for monitoring compliance with an oral hygiene program utilizing a conventional toothbrush comprising capturing the sound produced by the toothbrush as passes over the teeth and gums of a user with a removable microphone, analyzing the sound with conventional sound pattern recognition techniques, and notifying the user of their brushing effectiveness based upon the outcome of the sound analysis.

The method of capturing the sound produced by the toothbrush as passes over the teeth and gums of a user with a removable or remote microphone further comprises coupling the removable or remote microphone to the toothbrush prior to brushing, and decoupling the removable or remote microphone from the toothbrush after completing brushing.

The method of notifying the user of their brushing effectiveness based upon the outcome of the sound analysis further comprises sending an electronic signal to a digital display that displays a corresponding text and/or picture message to the user.

In another embodiment, the method notifying the user of their brushing effectiveness based upon the outcome of the sound analysis further comprises printing out a dental data report.

In another embodiment, the method of notifying the user of their brushing effectiveness based upon the outcome of the sound analysis further comprises uploading a dental data report to a computer or website.

In yet another embodiment, the method of notifying the user of their brushing effectiveness based upon the outcome of the sound analysis further comprises e-mailing a dental data report to a computer or website.

While the apparatus and method has or will be described for the sake of grammatical fluidity With functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a diagram of an embodiment of the dental cleaning system comprising a wire that leads from a microphone coupled to the toothbrush component to the digital display component.

FIG. 2 is a diagram of an embodiment of the dental cleaning system comprising a wireless microphone and transmitter coupled to the toothbrush component and a receiver coupled to the digital display component.

FIG. 3 is a diagram of an embodiment of the dental cleaning system comprising a remote microphone coupled to the digital display component.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The current invention is directed to a removable and attachable acoustic, electronic system that monitors the brushing patterns and brushing intensity of a user by analyzing the sound that is produced by a conventional tooth brush as it passes over the teeth and/or gums. The system couples to the user's toothbrush and as the user brushes, the sound is captured by a small microphone or transducer coupled to the toothbrush or by a remote microphone which is then transferred to a microprocessor coupled to a digital display.

After the microprocessor has distinguished and analyzed the brushing sounds, a corresponding message is displayed on the digital display that directs the user to continue brushing or change brushing habits, depending on the outcome of the analysis that is produced by the microprocessor.

After brushing, the user may then decouple or remove the system from the toothbrush and store the system for later use or the system may then be coupled or reattached to another user's toothbrush and the process repeated. The entire dental cleaning system is removable and transferable, allowing the user or a plurality of users to keep their existing toothbrush(es) and thus negate the need for the user to purchase a completely new and expensive dental cleaning device.

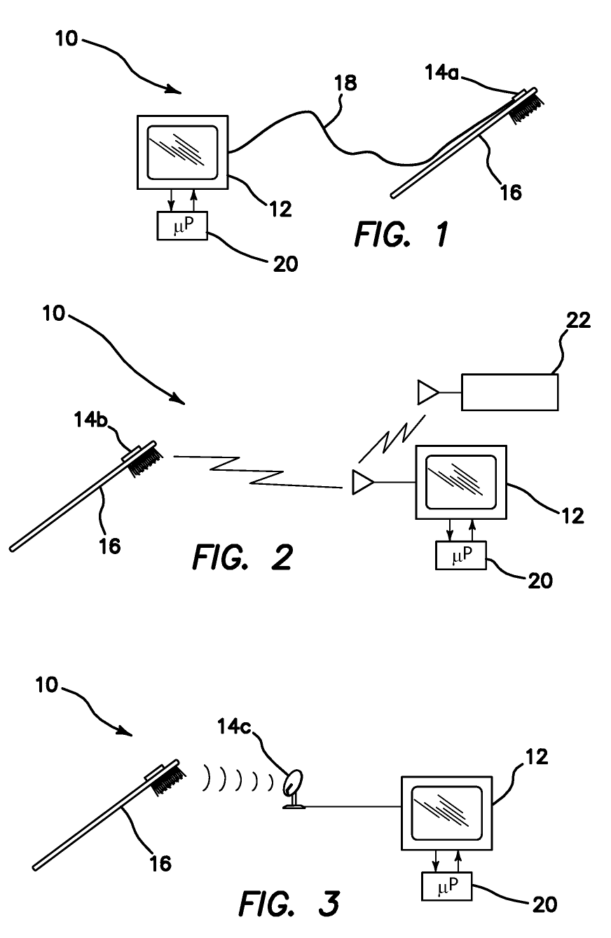

As shown in FIGS. 1-3, the current dental cleaning system is generally represented by reference numeral 10. The system 10 comprises a digital display 12 that resembles a digital timer with a digital read out. The digital display 12 is capable of displaying the elapsed time since brushing began, the brushing pattern of the user, the brushing intensity of the user, as well as a summary of the success of the brushing process in all of these parameters. It is to be expressly understood that other brushing parameters or oral health indicators may be selected according to well known dental hygiene goals and methods without departing from the original spirit and scope of the invention.

The display 12 may be powered by batteries or comprise a standard plug (not shown) for direct coupling into a standard wall socket. Alternatively, the batteries in the display 12 may be rechargeable according to standard design principles thus increasing the mobility and transferability of the system 10. The display is preferably battery powered, e.g. plug in, rechargeable batteries, disposable batteries. The microphone itself might have a disposable battery, with a button to turn it on or off, particularly if it is on the handle of the brush. Again, it could be wired to the display, eliminating the need for the battery.

The system 10 also comprises a sensitive microphone 14a that is capable of being coupled to a conventional toothbrush 16 near the brushhead as shown in FIG. 1. The receiving range of microphone 14a need not be limited to the audible range, but may include subaudible as well as ultrasonic frequencies. It is to be understood that “conventional toothbrush” is meant to include any toothbrush currently made or made at any time in the future, which does not incorporate acoustic processing circuitry as disclosed, i.e. a nonacoustic toothbrush. For example, manual brushes as well as electric or motorized toothbrushes of all types are considered as conventional within the meaning of this disclosure. Thus, “conventional tooth brush” includes all nonacoustic toothbrushes.

Returning to FIG. 1, the microphone 14a is constructed according to conventional design principals and is sufficiently small enough so that while it is mechanically and acoustically coupled to the brushhead of the toothbrush 16 it does not interfere with the brushing process. That is to say that the microphone 14a does not hinder or handicap the user during brushing by hitting or rubbing against the user's teeth or gums.

The microphone 14a is coupled to the toothbrush 16 by any removable means known in the art including waterproof tape, adhesive, Velcro, rubber bindings, clamps, clips or other types of mechanical fasteners. The removable means are durable and strong enough so that a user or plurality of users may easily and repeatedly couple and de-couple the microphone 14a to and from the toothbrush 16 as many times as needed. Additionally, in another embodiment, the microphone 14a comprises a means of coupling such that when it is initially coupled to the toothbrush 16, the effect is permanent and the microphone 14a effectively becomes a permanent component of the toothbrush 16.

The removable means are also universal enough so that they can be applied from one type of conventional toothbrush 16, for example a manual brush, to another type of conventional toothbrush 16, for example a electric or motorized brush, without significant need for alteration.

Alternatively, the microphone 14a may also comprise a small pin or needle element (not shown) so as to stick anywhere into the plastic or rubber material comprising the conventional toothbrush 16. This “push pin” technique allows for the microphone 14a to be placed anywhere by the user by hand on the conventional toothbrush 16 so long as the plastic or rubber comprising conventional toothbrush 16 is soft and pliable enough for the microphone 14a to be inserted into it.

The microphone 14a is coupled to the digital display 12 of system 10 by a wire 18 as shown in the embodiment of FIG. 1. Alternatively, a wireless microphone and transmitter 14b may be coupled in or on the toothbrush 16 as shown in FIG. 2, or an acoustically remote microphone 14c coupled to the digital display 12 may be placed elsewhere in the brushing area as shown in FIG. 3.

Once the user has coupled the microphone 14a-14c to a conventional toothbrush 16 in a manner described above, the user then begins to brush his or her teeth. As the bristles of the toothbrush 16 travel over the teeth and gums of the user, a corresponding sound is created. The microphone 14a-14c coupled to the toothbrush 16 picks up the brushing sounds which are communicated to the display 12 either by wire 18, by a receiver (not shown) coupled to the display 12, or the remote microphone 14c. Additionally, in another embodiment, the remote microphone 14c is a permanent component of the display 12 and cannot be decoupled. The brushing sounds are then transferred to a microprocessor 20 coupled to the digital display 12 which filters out extraneous sounds using conventional digital processing techniques, to selectively sense the unique types of sound patterns of dental brushing, and analyzes the sound patterns and intensity, customized or optimized for whatever toothbrush 16 the user may be using (hard, soft, electric, any manufacturer, or a proprietary tooth brush) to evaluate the pattern, time, and intensity of brushing or any other performance parameter as will be described in further detail below.

Briefly, each sound in nature has certain identifiable features such as phase and amplitude information that is unique to that sound. These unique features thus constitute a “sound signature” or “acoustic fingerprint” for that particular sound as is well known in the art. The sound that is created as a brush runs over the teeth and gums of a user is no different and using a method of pattern recognition according to well understood principles in the art, a computer is used to recognize the brushing sounds based on their sound signature and then display information to the user related to the variations or information incorporated into that sound according to the circumstances of its generation.

The microprocessor 20 of the system 10 comprises a memory storage device (not shown) such as a RAM, ROM, or FLASH chip, or a combination of such chips. A tutorial or “learning” program for the user to use before brushing may begin for the first time is pre-stored on the memory storage device to modify or customize a predetermined library of acoustic signatures known to be correlated to certain brushing behaviors. Upon initial activation of the system 10, the learning program works in tandem with the display 12 as it guides the user through several tutorial steps. One of the first of these steps includes recording an initial brush sound from the user. When prompted to by the learning program, the user brushes a selected portion of their teeth using any type of conventional toothbrush with the microphone 14a-14c recording the resulting sound on to the memory storage device coupled to the microprocessor 20. This sound then becomes the “base” or “target” sound, the sound for which all future brushings will be based on and compared to, for that particular section of teeth. This step is repeated for every portion of the user's teeth, for example for each dental quadrant.

Another tutorial step programmed into the microprocessor 20 is the option for the user to choose to have certain ambient sounds suppressed by the microprocessor 20 and thus improve the sound detection capabilities of the system 10. When this option is selected, the user records the sound of their current dental cleaning device or other undesirable background noise for a pre-selected period of time. The microprocessor 20 then stores the sound signature of the undesirable sound in the memory storage device. This is especially beneficial for those users who use an electric or mechanical toothbrush because when the system 10 is in use, the microprocessor 20 will automatically detect and then ignore the undesirable sound signature and thus not take in the undesirable sound, such as the sounds of the electronic motor of the toothbrush when not being used to brush the teeth, when making a brushing analysis.

Having completed the learning program, the user is then free to use the system 10 which is now customized to his or her specific toothbrush as well as to their particular dental profile.

As the user begins brushing with toothbrush 16, the sound of the brushing is picked up by the microphones 14a-14c and then transferred to the microprocessor 20 coupled to the digital display 12. The microprocessor 20 takes the incoming sound signature from the microphone 14a-14c and compares it to the pre-saved “target” sound signatures. If the received sound signature is substantially similar to any of the target sound signatures, the microprocessor 20 determines that brushing is taking place and a corresponding signal is sent to the digital display 12 which in turn displays a digital timer displaying how much time has elapsed since brushing has began.

The microprocessor 20 may also detect when the brushing intensity, the brushing pattern, or other brushing related indicator of the user is acceptable or not. Using standard sound detection and analysis methods, if the incoming sound signature from the user is similar to the target sound but is lacking in certain acoustic parameters such as amplitude and the like, the microprocessor 20 will then send a corresponding signal the display 12 that tells the user how to improve their brushing techniques. For example, if the brushing is deemed to be too hard by the microprocessor 20, then an appropriate signal is sent to the display 12 which then displays a text or picture message to the user not to brush so hard. Using this method, the system 10 slowly teaches and guides the user in real-time during brushing, thus improving their overall dental cleaning ability and increasing dental health.

Over time, the microprocessor 20 may also be used detect slight variations in the sound that the brush makes as it passes over the teeth and gums of the user on a daily basis. Once the microprocessor 20 has detected that the sound signals coming from the toothbrush 16 are continually within a pre-selected range of unacceptable signal analysis for a pre-selected period of time, the microprocessor 20 notifies the user when the toothbrush 16 has possibly reached the end of its effective lifespan and that a replacement is required.

Additionally, the microprocessor 20 may provide the user with an “effective” amount of brushing time which may or may not be different from the total elapsed brushing time. After brushing has begun, the microprocessor 20 defines an acceptable margin of error and based on conventional sound analysis software, determines how close the incoming sound signature is to the target sound signature by constantly comparing and analyzing the two sound signatures against each other. If the incoming sound signature is within the margin of error, the microprocessor 20 counts the elapsed time as “effective” or “good” brushing. This amount of time is then accumulated in an effective brushing clock that is displayed on display 12. If the incoming sound signature is outside the margin of error, the microprocessor 20 counts this time as “ineffective” or “bad” brushing. When bad brushing is detected by the microprocessor 20, the effective brushing clock stops counting and the amount of bad brushing time is not added to the effective brushing clock. Only when the incoming sound signature returns within the margin of error does the effective brushing clock start again and continue to accumulate time for as long as the brushing is detected as “effective” by the microprocessor 20.

It is through this process that the user then receives an accurate real-time metric for which to judge his or her brushing by. For example, if the user is attempting to brush his teeth for the dentist recommended two minutes, the process described above will ensure that the user brushes until a full two minutes of effective brushing have elapsed. If the user is a skilled or “fast” brusher, then the amount of effective brushing time will be close to the total elapsed brushing time and thus increase efficiency. If the user is not as skilled, then the process described above will force him to continue to brush until a full two minutes of effective brushing have taken place, thus ensuring a proper dental cleaning.

In FIG. 2, a computer or website 22 is coupled to the system 10. The microprocessor 20 may upload recent dental cleaning data such as brushing statistics and the last time brushing took place to the computer or website 22 by means according to standard practice. Once the dental data has been uploaded to the computer or website 22, a family member or dental professional may view it and correspond with the user about their specific dental cleaning habits. In this fashion the user may receive additional feedback and instructions over their individual brushing techniques and thus further improve their dental health. The website 22 also may record and include historic data concerning the user's brushing patterns and frequencies to chart the oral hygiene habits of the user and to provide not only a historic use chart, but an individualized course of oral hygiene treatment and recommendations specific to the user depending on recorded usages.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. An apparatus for monitoring compliance with an oral hygiene program utilizing a conventional toothbrush comprising:
a microphone with means for receiving acoustic signals generated by the oral use of the toothbrush;
a electronic display coupled to the microphone with means for displaying selected parameters related to the oral use of the toothbrush; and
a microprocessor coupled to the display to identify, record and report the acoustic signals.

2. The apparatus of claim 1 where the microphone is coupled to or in the toothbrush and further comprises a means for coupling to the display.

3. The apparatus of claim 2 where the means for coupling to the display further comprise a wire coupled to the microphone at its distal end and coupled to the display at its proximal end.

4. The apparatus of claim of claim 2 where the means for coupling to the display further comprise a transceiver coupled to the microphone and a receiver coupled to the display.

5. The apparatus of claim 1 where the microphone is directly disposed on the display.

6. The apparatus according to any one of the preceding claims where the microprocessor further comprises a means for recording the sounds of brushing patterns and brushing intensity produced by the toothbrush passing over a user's teeth and acquired by the microphone.

7. The apparatus of claim 6 where the microprocessor comprises a means for analyzing a incoming sound, determining if brushing is taking place, and then sending a signal to the display notifying the user whether brushing has begun or not.

8. The apparatus of claims 6 or 7 where the microprocessor comprises a means for analyzing of an incoming sound to within a pre-selected margin of error.

9. The apparatus of claim 8 where the analyzing of an incoming sound to within a pre-selected margin of error further comprises a means for sending a signal to the display to notify the user that effective brushing is taking place when the incoming sound is within the pre-selected margin of error, and that ineffective brushing is taking place when the incoming sound is not within the pre-selected margin of error.

10. The apparatus according to any one of the preceding claims where the microprocessor further comprises a means for filtering out extraneous sounds.

11. The apparatus according to any one of the preceding claims where the microprocessor comprises a means for customizing to whatever toothbrush the user may be using to evaluate the pattern, time, and intensity of brushing, effective lifespan of the toothbrush, and any other performance parameter.

12. The apparatus according to any one of the preceding claims where the microprocessor further comprises a means for producing data as a printed report.

13. The apparatus according to any one of the preceding claims where the microprocessor further comprises a means for wirelessly uploading a dental data report to a computer or website

14. The apparatus according to any one of the preceding claims where the microprocessor further comprises a means for e-mailing a dental data report to a computer or website.

15. A method for monitoring compliance with an oral hygiene program utilizing a conventional toothbrush comprising:
capturing the sound produced by the toothbrush as passes over the teeth and gums of a user with a microphone;
analyzing the sound with conventional sound pattern recognition techniques; and
notifying the user of their brushing effectiveness based upon the outcome of the sound analysis.

16. The method of claim 15 where capturing the sound produced by the toothbrush as passes over the teeth and gums of a user with a microphone further comprises coupling the microphone to the toothbrush prior to brushing, and decoupling the microphone from the toothbrush after completing brushing.

17. The method according to claim 15 or 16 where notifying the user of their brushing effectiveness based upon the outcome of the sound analysis further comprises sending an electronic signal to a digital display that displays a corresponding text and/or picture message to the user.

18. The method according to claim 15 or 16 where notifying the user of their brushing effectiveness based upon the outcome of the sound analysis further comprises printing out a dental data report.

19. The method according to claim 15 or 16 where notifying the user of their brushing effectiveness based upon the outcome of the sound analysis further comprises uploading a dental data report to a computer or website.

20. The method according to claim 15 or 16 where notifying the user of their brushing effectiveness based upon the outcome of the sound analysis further comprises e-mailing a dental data report to a computer or website.
